(19) United States
(12) Patent Application Publication
(10) Pub. No.: US 2026/0086072 A1
(43) Pub. Date: Mar. 26, 2026

(54) CHROMATOGRAM DATA PROCESSING APPARATUS

(71) Applicant: SHIMADZU CORPORATION, Kyoto (JP)

(72) Inventor: Yuji KATSUYAMA, Kyoto-shi (JP)

(73) Assignee: SHIMADZU CORPORATION, Kyoto (JP)

(21) Appl. No.: 19/322,570

(22) Filed: Sep. 8, 2025

(30) Foreign Application Priority Data
Sep. 24, 2024 (JP) 2024-164907

(51) Int. Cl. G01N 30/86

(52) U.S. Cl. CPC G01N 30/8631; G01N 30/8627

(57) ABSTRACT

A chromatogram data processing apparatus comprises: a chromatogram acquisition unit 24 configured to acquire a chromatogram; a parameter designation receiving unit 22 configured to receive an operation for designating a plurality of values for a predetermined waveform processing parameter; a waveform processing execution unit 24 configured to execute waveform processing on said chromatogram by applying each of the plurality of values of said predetermined waveform processing parameter received by the parameter designation receiving unit; and a display control unit 25 configured to cause a display device 32 to display a first waveform processing result acquired by waveform processing to which one of the plurality of values of said predetermined waveform processing parameter is applied, and a second waveform processing result acquired by waveform processing to which another one of said plurality of values is applied.

### TECHNICAL FIELD

The present invention relates to a chromatogram data processing apparatus.

### BACKGROUND ART

In a chromatograph such as a gas chromatograph or a liquid chromatograph, sample components that have been temporally separated by a column are detected by a detector such as an ultraviolet-visible spectrophotometer. Based on this detection signal, a chromatogram is created that shows the temporal change in signal intensity. To perform qualitative or quantitative analysis of the various components contained in a sample, it is necessary to identify the peaks included in the obtained chromatogram. Such peak identification is generally performed by an automatic detection algorithm. The process of identifying each peak in a chromatogram using such an automatic detection algorithm is hereinafter referred to as waveform processing.

To obtain an appropriate waveform processing result with an automatic detection algorithm, it is necessary to appropriately set various parameters related to waveform processing (hereinafter referred to as waveform processing parameters). As waveform processing parameters, for example, parameters such as “Width” or “Slope” are used. “Width” is the minimum value of the full width at half maximum to be determined as a peak in waveform processing. “Slope” is the threshold for the slope of the waveform to be determined as the rising position or falling position of a peak in waveform processing.

### PRIOR ART DOCUMENTS

### Patent Literature

[Patent Literature 1] Japanese Patent No. 5270439

### SUMMARY OF THE INVENTION

### Problem to be Solved by the Invention

Conventionally, when performing waveform processing on a chromatogram obtained by analyzing a sample, an analyst (operator) first specifies appropriate values for various waveform processing parameters on a predetermined setting screen, and then executes waveform processing on the chromatogram using an automatic detection algorithm. Then, the operator visually confirms the obtained waveform processing result and, if necessary, reopens the setting screen to change the values of the various waveform processing parameters and execute the waveform processing again. This process needs to be repeated until an appropriate waveform processing result is obtained. Such a task is complicated and poses a problem of a heavy workload for the operator.

The present invention has been made in view of the above points, and an object thereof is to reduce the operator's workload related to the setting of waveform processing parameters.

### Means for Solving the Problem

To solve the above problem, a chromatogram data processing apparatus according to the present invention comprises:
a chromatogram acquisition unit configured to acquire a chromatogram;
a parameter designation receiving unit configured to receive an operation for designating
a plurality of values for a predetermined waveform processing parameter;
a waveform processing execution unit configured to execute waveform processing on the chromatogram by applying each of the plurality of values of the predetermined waveform processing parameter received by the parameter designation receiving unit; and
a display control unit configured to cause a display device to display a first waveform processing result acquired by waveform processing to which one of the plurality of values of the predetermined waveform processing parameter is applied, and a second waveform processing result acquired by waveform processing to which another one of the plurality of values is applied.

### Effects of the Invention

According to the chromatogram data processing apparatus of the present invention having the above configuration, by the operator performing a single parameter designation operation on the parameter designation receiving unit (i.e., an operation to designate a plurality of values for the predetermined waveform processing parameter), a plurality of waveform processing results obtained by executing waveform processing on the chromatogram with mutually different parameter values are displayed on the display device. Therefore, the operator's workload related to the setting of waveform processing parameters can be reduced.

### BRIEF DESCRIPTION OF THE DRAWINGS

FIG. 1 is a diagram showing the main configuration of a chromatograph system according to an embodiment of the present invention.

FIG. 2 is a conceptual diagram showing the separation of chromatogram peaks by vertical division.

FIG. 3 is a conceptual diagram showing the separation of chromatogram peaks by complete separation.

FIG. 4 is a flowchart showing an example of the operation of a data processing apparatus included in the embodiment.

FIG. 5 is a diagram showing an example of a parameter setting screen.

FIG. 6 is a diagram showing another example of a parameter setting screen.

FIG. 7 is a diagram showing an example of a display format for waveform processing results.

FIG. 8 is a flowchart showing another example of the operation of the data processing apparatus.

FIG. 9 is a diagram showing another example of a display format for waveform processing results.

### DESCRIPTION OF EMBODIMENTS

Hereinafter, an embodiment for carrying out the present invention will be described with reference to the drawings. FIG. 1 is a diagram showing the main configuration of a chromatograph system according to the present embodiment. As shown in the figure, this chromatograph system comprises a chromatograph unit 10 and a data processing apparatus 20. This data processing apparatus 20 corresponds to the chromatogram data processing apparatus in the present invention. The chromatograph unit 10 may be a liquid chromatograph or a gas chromatograph, but will be described below as a liquid chromatograph.

The chromatograph unit 10 comprises a liquid feed pump 11, a sample introduction unit 12, a column 13, and a detector 14. The liquid feed pump 11 supplies a mobile phase stored in a mobile phase container (not shown) to the column 13. The sample introduction unit 12 injects a predetermined amount of sample into the mobile phase flow path leading from the liquid feed pump 11 to the column 13. The components in the sample (sample components), carried by the flow of the mobile phase and introduced into the column 13, are separated from each other in the process of passing through the column 13 and are sequentially eluted from the outlet end of the column 13. The outlet end of the column 13 is connected to the detector 14, and each sample component eluted from the column 13 is detected by this detector 14. As the detector 14, for example, an optical detector using a photodiode array (PDA) or a mass spectrometer can be used, but it is not limited to these.

The signal output from the detector 14 is converted into digital data by an A/D converter (not shown) and then input to the data processing apparatus 20. The data processing apparatus 20 is for performing predetermined processing on this digital data, and its actual entity is a computer (e.g., a personal computer) equipped with a CPU, memory, and a mass storage device (e.g., an HDD or SSD). Connected to the computer are an input unit 31 (corresponding to the transition stop operation receiving unit and the waveform processing result selection receiving unit in the present invention) including a pointing device such as a mouse or a keyboard, and a display unit 32 including a liquid crystal display or an organic EL display. The data processing apparatus 20 includes, as functional blocks, a chromatogram generation unit 21, a parameter designation receiving unit 22, a parameter value combination generation unit 23, a waveform processing unit 24 (corresponding to the chromatogram acquisition unit and the waveform processing execution unit in the present invention), and a display control unit 25. These are functional means realized by a CPU of the computer executing a predetermined program installed on the computer. Furthermore, the data processing apparatus 20 includes a chromatogram storage unit 26, a parameter value combination storage unit 27, a final result storage unit 28 (corresponding to the waveform processing result storage unit in the present invention), and a parameter storage unit 29 (corresponding to the waveform processing parameter storage unit in the present invention). These functions are realized by a mass storage device provided in the computer.

The digital data input to the data processing apparatus 20 is sent to the chromatogram generation unit 21. The chromatogram generation unit 21 generates a chromatogram, which is a waveform showing the temporal change in signal intensity, based on the digital data, and stores it in the chromatogram storage unit 26.

The waveform processing unit 24 identifies peaks on the chromatogram based on predetermined parameters (waveform processing parameters). Examples of the parameters include “Slope”, “Width”, and “Peak separation method”.

“Slope” is a threshold for the slope of the waveform (intensity/time) for detecting a peak start point and a peak end point. For example, if the Slope value is 100 μV/sec, in the direction from left to right on the horizontal axis (time axis) of the chromatogram, the point in time when the slope of the waveform first exceeds 100 μV/sec is recognized as the peak start point. After that, around the peak top, the slope of the waveform becomes a negative value and further falls below −100 μV/sec. Then, the point in time when the slope of the waveform again becomes greater than −100 μV/sec is recognized as the peak end point. Therefore, the positions of the detected peak start point and peak end point change depending on the value of “Slope”.

“Width” is the minimum value of the full width at half maximum of a peak to be detected. For example, if the Width value is 5 sec, among the regions from the peak start point through the peak top to the peak end point on the chromatogram, a region with a full width at half maximum of 5 sec or more is determined to be a peak, and a region with a full width at half maximum of less than 5 sec is determined to be noise. Therefore, by setting a large value for “Width”, it is possible to prevent noise from being detected as a peak. On the other hand, when the value of “Width” is increased, adjacent peaks that partially overlap are more likely to be detected as a single peak.

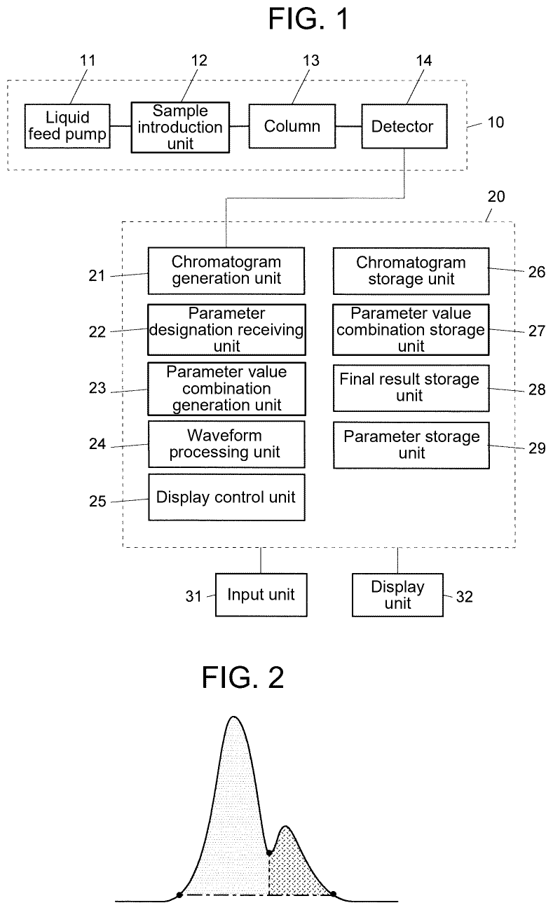

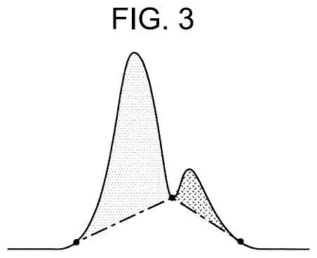

“Peak separation method” is a type of method for dividing a peak group composed of partially overlapping adjacent peaks into multiple peaks, and includes vertical division or complete separation (baseline separation). Vertical division, as shown in FIG. 2, is a method of dividing adjacent peaks by a perpendicular line (dashed line in the figure) dropped from the valley between the two adjacent peaks (the point of minimum intensity in the region between the peak tops of both peaks) to a single horizontal baseline (dash-dotted line in the figure) set for the peak group. In this method, the area of each peak is the area of the region (shaded area in FIG. 2) enclosed by the waveform from the peak start point through the peak top to the peak end point, the baseline, and the perpendicular line. On the other hand, complete separation, as shown in FIG. 3, is a method of dividing adjacent peaks by setting a baseline (dash-dotted line in the figure) that connects the start and end points for each peak included in the peak group. In this method, the area of each peak is the area of the region (shaded area in FIG. 3) enclosed by the waveform from the peak start point through the peak top to the peak end point, and the baseline. Therefore, by changing the peak separation method, the size of the area recognized as the area of each peak changes, and as a result, the quantitative value of the component corresponding to each peak changes.

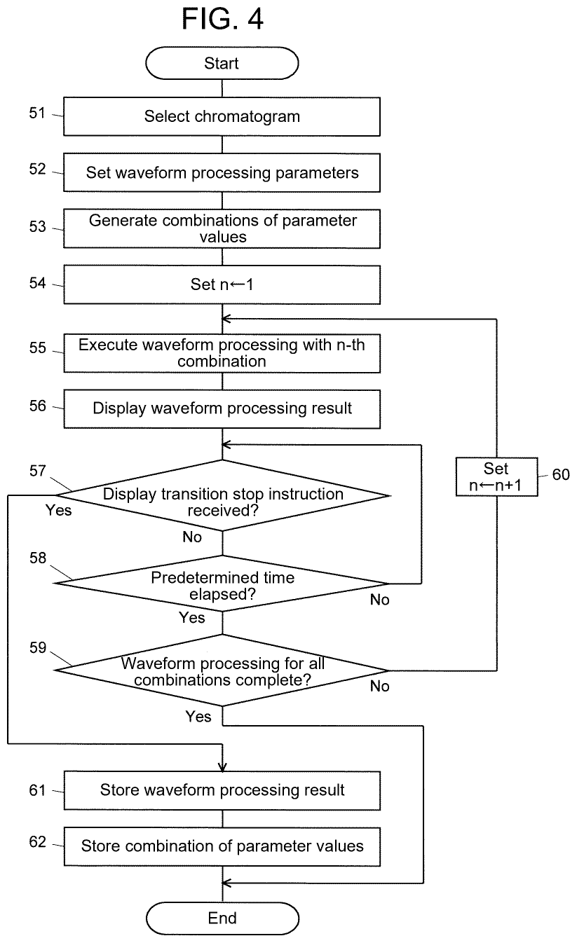

Hereinafter, a characteristic operation of the data processing apparatus 20 according to the present embodiment will be described with reference to the flowchart of FIG. 4. Here, it is assumed that data of one or more chromatograms generated by the chromatogram generation unit 21 in conjunction with the analysis of a sample in the chromatograph unit 10 has been previously stored in the chromatogram storage unit 26.

First, when the operator performs a predetermined operation using the input unit 31, a chromatogram selection screen (not shown) for selecting the target of waveform processing (hereinafter referred to as the target chromatogram) from the one or more chromatograms stored in the chromatogram storage unit 26 is displayed on the display unit 32. When the operator selects an appropriate chromatogram on this screen (step S51), the parameter designation receiving unit 22 subsequently displays a parameter setting screen on the display unit 32 for the operator to set waveform processing parameters.

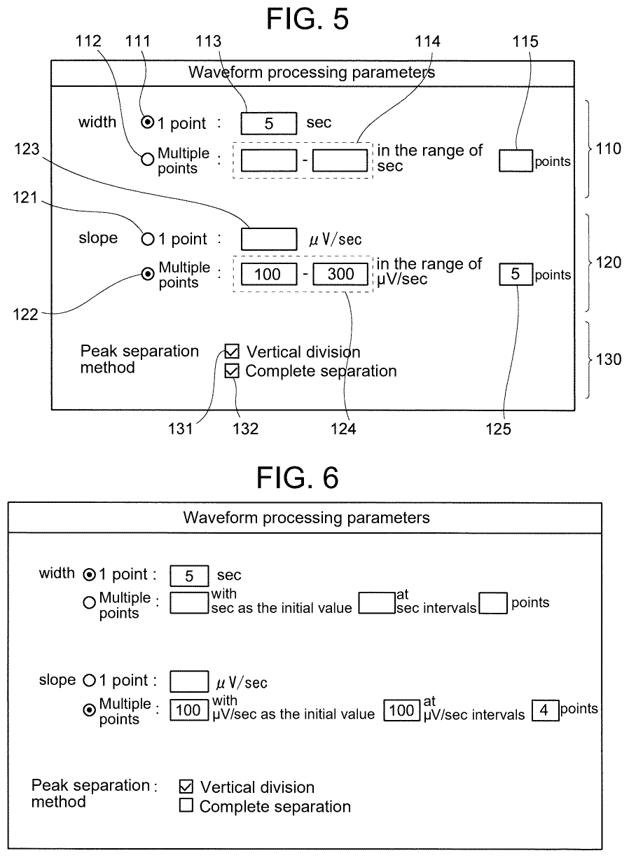

FIG. 5 shows an example of the parameter setting screen. This screen is provided with a Width value designation area 110, a Slope value designation area 120, and a peak separation method designation area 130.

The Width value designation area 110 is provided with radio buttons 111 and 112 for selecting whether to designate only one Width value or multiple Width values. When designating only one Width value, the operator selects the upper radio button 111 and inputs only one appropriate numerical value into the Width value input field 113 to the right of the radio button 111. On the other hand, when designating multiple Width values, the operator selects the lower radio button 112, inputs the upper and lower limit values for the Width value into the Width value range input field 114 to its right, and further inputs a data point setting value, which represents how many Width value points are to be set within the numerical range defined by the upper and lower limit values, into the Width value point count input field 115 next to it. Instead of the data point setting value, a step value, which is the width of the divided values, may be input. For example, if the upper limit of Width is set to 1.0, the lower limit to 0.5, and the data point setting value to 6, a combination of values 1.0, 0.9, 0.8, 0.7, 0.6, and 0.5 is set. On the other hand, if the same upper and lower limits are set and the step value is set to 0.1, the same combination of values is set.

Similarly, the Slope value designation area 120 is provided with radio buttons 121 and 122 for selecting whether to designate only one Slope value or multiple Slope values. When designating only one Slope value, the operator selects the upper radio button 121 and inputs only one appropriate numerical value into the Slope value input field 123 to the right of the radio button 121. On the other hand, when designating multiple Slope values, the operator selects the lower radio button 122, inputs the upper and lower limit values for the Slope value into the Slope value range input field 124 to its right, and further inputs how many Slope value points are to be set within the numerical range defined by the upper and lower limit values into the Slope value point count input field 125 next to it.

The peak separation method designation area 130 is provided with a checkbox 131 for selecting vertical division and a checkbox 132 for selecting complete separation as the peak separation method. The operator can check either one or both of these checkboxes 131 and 132.

Although here, when designating multiple Width values or Slope values, the operator is made to specify the range of the Width or Slope value and how many points to set for the Width or Slope value within that range (or with what step value), alternatively, the operator may be made to specify an initial value for the Width or Slope value, and with what step value and how many points to set the Slope or Width value from that initial value. FIG. 6 shows an example of a parameter setting screen in such a case.

After the operator sets the parameter values (i.e., Width value, Slope value, and type of peak separation method) on the parameter setting screen as shown in FIG. 5 or FIG. 6 (step S52) and then performs a predetermined operation with the input unit 31, the parameter value combination generation unit 23 generates combinations of parameter values derived from the content input on the parameter setting screen (step S53). For example, in the example shown in FIG. 5, one Width value (5 sec), five Slope values (100 μV/sec, 150 μV/sec, 200 μV/sec, 250 μV/sec, and 300 μV/sec), and two types of peak separation methods (vertical division and complete separation) are designated. Therefore, 1×5×2=10 combinations of these Width values, Slope values, and peak separation method types are generated. In the example shown in FIG. 6, one Width value (5 sec), four Slope values (100 μV/sec, 200 μV/sec, 300 μV/sec, and 400 μV/sec), and one type of peak separation method (vertical division only) are designated. Therefore, 1×4×1=4 combinations of these Width values, Slope values, and peak separation method types are generated.

The combinations of parameter values generated as described above are stored in the parameter value combination storage unit 27.

Subsequently, the waveform processing unit 24 sets a counter value n for waveform processing to 1 (step S54). Then, the waveform processing unit 24 reads the target chromatogram specified in step S51 from the chromatogram storage unit 26, reads the first combination from the combinations of parameter values stored in the parameter value combination storage unit 27 (hereinafter sometimes simply referred to as combinations), and executes waveform processing on the target chromatogram using the first combination (step S55). The waveform processing result obtained thereby is displayed on the display unit 32 under the control of the display control unit 25 (step S56).

After that, when a predetermined time (e.g., several seconds to a dozen seconds) has elapsed (when step S58 becomes Yes), the waveform processing unit 24 determines whether waveform processing for all combinations generated in step S53 has been completed (step S59). If it determines that it has not been completed, it increments the counter value n (step S60), executes waveform processing with the second combination (step S55), and causes the display control unit 25 to display the result on the display unit 32 (step S56). As a result, the display unit 32 transitions from a state displaying the waveform processing result of the first combination (hereinafter referred to as the first state) to a state displaying the waveform processing result of the second combination (hereinafter referred to as the second state).

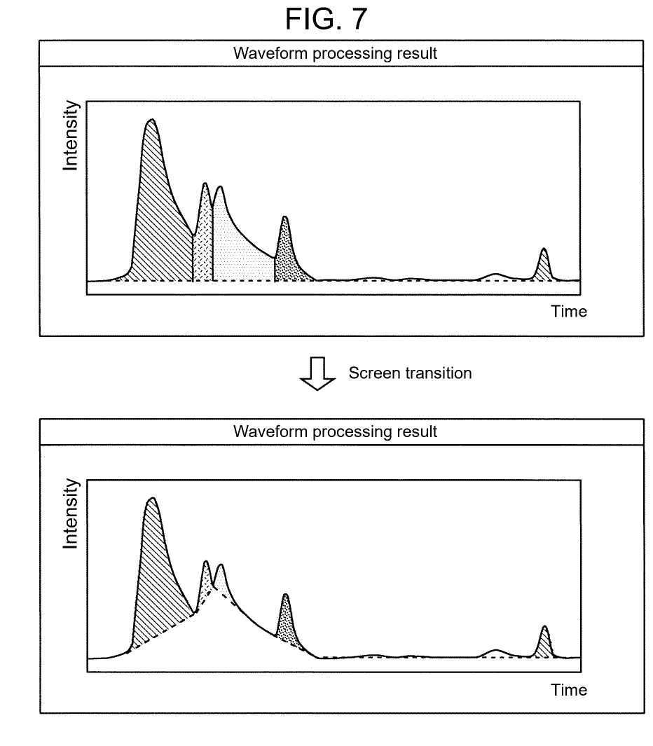

Thereafter, steps S55 to S60 are repeatedly executed until it is determined in step S59 that waveform processing for all combinations has been completed (step S57 will be described later). FIG. 7 shows an example of the display content on the display unit 32 at this time. The upper part of the figure shows a state where the waveform processing result for the k-th combination (k is an integer, 1≤k<x) among x combinations (x is an integer of 2 or more) stored in the parameter value combination storage unit 27 is displayed. The lower part of the figure shows a state where the waveform processing result for the (k+1)-th combination is displayed due to the subsequent screen transition. In the example in the figure, as the waveform processing result, a display is shown in which a line indicating a baseline or a line indicating the boundary of adjacent peaks, or both, and shading indicating a peak area are superimposed on the waveform of the target chromatogram.

The upper part of FIG. 7 shows the result of separating adjacent peaks by vertical division, and the lower part of FIG. 7 shows the result of separating adjacent peaks by complete separation.

The operator visually observes the sequentially transitioning display content on the display unit 32, and when it is determined that an appropriate waveform processing result is displayed, the operator inputs an instruction to stop the transition of the display content via the input unit 31. This instruction is hereinafter referred to as a display transition stop instruction.

When the display transition stop instruction is input (i.e., when Yes in step S57), the display control unit 25 stops the transition of the display content on the display unit 32, and stores the waveform processing result displayed at that time as the final waveform processing result for the target chromatogram in the final result storage unit 28 (step S61). Furthermore, the waveform processing unit 24 reads the combination of parameter values at the time the final waveform processing result was obtained from the parameter value combination storage unit 27, stores this combination as the combination of parameter values to be applied to future waveform processing in the parameter storage unit 29 (step S62), and terminates the series of processes.

Therefore, for example, if a display transition stop instruction is input while the waveform processing result for the m-th combination (m is an integer, 1≤m<x) among x combinations (x is an integer of 2 or more) stored in the parameter value combination storage unit 27 is being displayed, the waveform processing for the (m+1)-th and subsequent combinations and the display of the results of said waveform processing will not be executed.

If it is determined that waveform processing for all combinations (i.e., the x combinations) has been completed without a display transition stop instruction being input from the operator (i.e., when Yes in step S59), the series of processes ends without steps S61 and S62 being executed.

As described above, in the data processing apparatus according to this embodiment, when the operator performs a single setting operation (i.e., the setting operation on the waveform processing parameter setting screen), the results of waveform processing with various parameter values changed are sequentially displayed on the display unit 32. Then, when an appropriate waveform processing result is displayed, the operator inputs a display transition stop instruction, whereby the waveform processing result is stored as the final waveform processing result, and the combination of parameter values applied at that time is stored as the combination of parameter values to be applied thereafter. Therefore, unlike the conventional method where the operator needs to repeatedly input parameter values on a predetermined setting screen and visually confirm the waveform processing result obtained by applying those parameter values to search for the optimal parameter values, the operator's workload related to determining parameter values can be reduced.

In the above description, the combination of parameter values corresponding to the waveform processing result displayed on the display unit 32 at the time the operator inputs the display transition stop instruction (i.e., the combination of parameter values at the time the waveform processing result was obtained) is stored as the combination of parameter values to be applied thereafter. However, after the display transition stop instruction is input, it may be possible to narrow down the parameter values.

Specifically, for example, upon receiving the display transition stop instruction from the operator, the display control unit 25 causes the display unit 32 to display a screen that allows the operator to select whether to decide the waveform processing result currently displayed as the final waveform processing result for the target chromatogram or to narrow down the parameter values. Then, if the operator selects to narrow down the parameter values on that screen, the display control unit 25 causes the display unit 32 to display a screen similar to the parameter setting screen shown in FIG. 5 or FIG. 6.

On the screen displayed at this time (hereinafter referred to as the parameter re-setting screen), the operator may be allowed to freely set the values of each parameter. However, for a parameter for which three or more values were designated in step S52, it may be possible to designate it within a predetermined range including the value that was applied when the display transition stop instruction was input (hereinafter referred to as a temporary parameter value), while not accepting changes to other parameters. In that case, the predetermined range shall be a range that does not include values other than the temporary parameter value among the three or more values. For example, if each parameter value is specified as in the example shown in FIG. 5 in step S52, and a display transition stop instruction (step S57) is input while the waveform processing result applying a Width value of 5 sec, a Slope value of 200 μV/sec, and vertical division as the peak separation method is being displayed in step S56, then on the parameter re-setting screen, input of the Width value and peak separation method is not accepted, and the Slope value can be set to multiple values in a range greater than 150 μV/sec and less than 250 μV/sec.

Subsequently, in the same manner as step S53 described above, combinations of parameter values derived from the content input on the parameter re-setting screen are generated. For example, in the above example, as the combination of parameter values, multiple combinations are generated with the Width value fixed at 5 sec, the peak separation method fixed at vertical division, and only the Slope value varied. Thereafter, processes similar to steps S54 to S62 are executed.

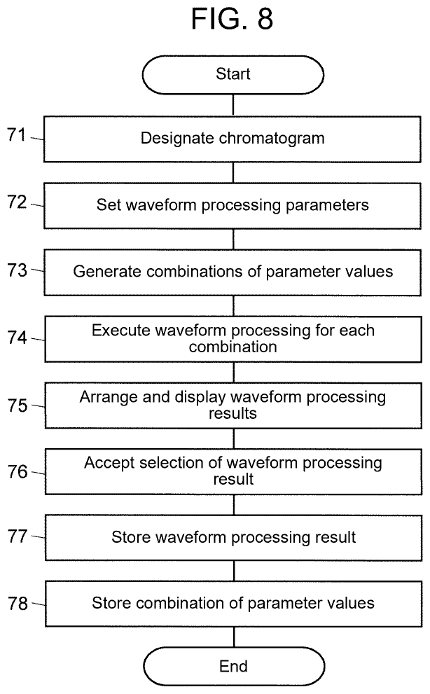

Although the embodiment for carrying out the present invention has been described with specific examples, the present invention is not limited to the above, and appropriate modifications are permissible within the spirit of the present invention. For example, in the above embodiment, the waveform processing applying one of the combinations of parameter values generated in step S53 (step S55) and the display of its waveform processing result (step S56) are repeatedly executed at predetermined time intervals. Alternatively, after all waveform processing applying each of the combinations of parameter values generated in step S53 has been executed, the results of each waveform processing may be displayed side-by-side on the screen of the display unit 32. The operation of the data processing apparatus 20 in that case will be described below with reference to the flowchart of FIG. 8.

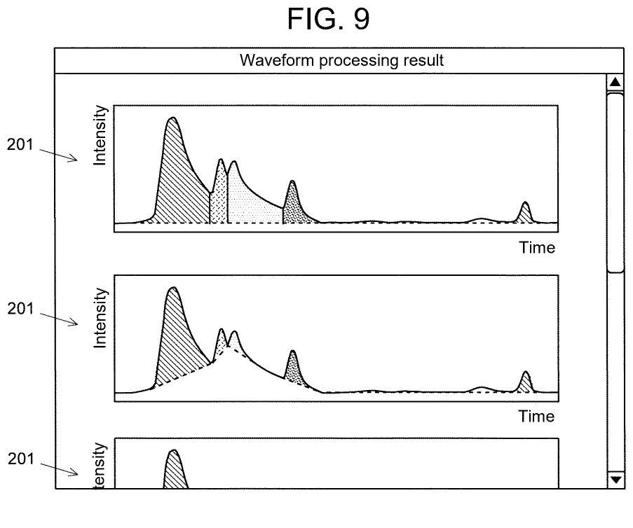

First, similarly to steps S51 to S53 described above, designation of the target chromatogram (step S71), setting of waveform processing parameters (step S72), and generation of combinations of parameter values (step S73) are executed. Thereafter, the waveform processing unit 24 reads all combinations of parameter values (i.e., the x combinations) stored in the parameter value combination storage unit 27 and applies each to the target parameter, thereby generating x waveform processing results (step S74). Subsequently, the display control unit 25 causes the x waveform processing results to be displayed side-by-side on the screen of the display unit 32 (step S75). FIG. 9 shows an example of the display screen at this time (hereinafter referred to as the waveform processing result display screen). In the example of the figure, a plurality of waveform processing results 201 are displayed in a single vertical column within the waveform processing result display screen, and the operator can check all waveform processing results 201 by scrolling the screen up and down via the input unit 31. The x waveform processing results may be displayed in a list within the waveform processing result display screen, or the waveform processing result display screen may consist of multiple pages, with the x waveform processing results displayed over multiple pages. The operator visually confirms each waveform processing result 201 displayed on the waveform processing result display screen and selects an appropriate one by a click operation or the like (step S76). As a result, the selected waveform processing result 201 is stored as the final waveform processing result for the target chromatogram in the final result storage unit 28 (step S77), and the combination of parameter values corresponding to the waveform processing result is stored as the combination of parameter values to be applied to subsequent waveform processing in the parameter storage unit 29 (step S78). In this case as well, it may be possible to narrow down the parameter values as described above.

Furthermore, after generating the x waveform processing results (i.e., after executing step S74 above), the results of the x waveform processing may be displayed one by one in order on the display unit 32 at predetermined time intervals. In that case, when a display transition stop instruction is input from the operator, the transition of the display content is stopped, the waveform processing result displayed at that time is stored as the final waveform processing result in the final result storage unit 28, and the combination of parameter values corresponding to the waveform processing result is stored as the combination of parameter values to be applied to future waveform processing in the parameter storage unit 29. In this case, for example, if a display transition stop instruction is input while the waveform processing result for the m-th combination (m is an integer, 1<m<x) among the x combinations is being displayed, the display of the waveform processing results for the (m+1)-th and subsequent combinations will not be executed.

In the above-described embodiment, the parameter setting screen (and the parameter value re-setting screen) allows for the designation of the Slope value, Width value, and the type of peak separation method as parameter values. However, in addition to or instead of these, other waveform processing parameters, for example, minimum peak area (minimum value of the area of a region determined to be a peak), minimum peak height (minimum value of the height of a peak top determined to be a peak), or drift value (upper limit of the allowable range of the baseline slope in complete separation), may be made settable, and for some or all of them, multiple values may be made settable.

In the above embodiment, the configuration was such that the computer constituting the data processing apparatus 20 was provided with the chromatogram generation unit 21, the chromatogram storage unit 26, and the waveform processing unit 24. However, the data processing apparatus according to the present invention may have the waveform processing unit 24 and not have the chromatogram generation unit 21 and the chromatogram storage unit 26. In that case, the waveform processing unit 24 acquires a chromatogram generated by a computer different from the computer constituting the data processing apparatus 20 from said different computer via a network such as a LAN or the Internet, and performs waveform processing on said chromatogram.

### Aspects

It will be apparent to those skilled in the art that the exemplary embodiments described above are specific examples of the following aspects.

(First Aspect) A chromatogram data processing apparatus according to one aspect of the present invention comprises:
a chromatogram acquisition unit configured to acquire a chromatogram;
a parameter designation receiving unit configured to receive an operation for designating a plurality of values for a predetermined waveform processing parameter;
a waveform processing execution unit configured to execute waveform processing on the chromatogram by applying each of the plurality of values of the predetermined waveform processing parameter received by the parameter designation receiving unit; and
a display control unit configured to cause a display device to display a first waveform processing result acquired by waveform processing to which one of the plurality of values of the predetermined waveform processing parameter is applied, and a second waveform processing result acquired by waveform processing to which another one of the plurality of values is applied.

(Second Aspect) The chromatogram data processing apparatus according to the first aspect, wherein
the display control unit causes the display device to transition from a first state, which is a state displaying the first waveform processing result, to a second state, which is a state displaying the second waveform processing result,
the apparatus further comprising:
a transition stop operation receiving unit configured to receive an operation for stopping the transition of the display device from the first state to the second state, provided in the display control unit.

(Third Aspect) The chromatogram data processing apparatus according to the first or second aspect, wherein
the parameter designation receiving unit receives designation of an upper limit value, a lower limit value, and a data point setting value representing the number of data points to be set for the predetermined waveform processing parameter.

(Fourth Aspect) The chromatogram data processing apparatus according to the first or second aspect, wherein
the parameter designation receiving unit receives designation of an upper limit value, a lower limit value, and a step value representing an interval of change for the waveform processing parameter for the predetermined waveform processing parameter.

(Fifth Aspect) The chromatogram data processing apparatus according to any one of the first to fourth aspects, further comprising:
a waveform processing result selection receiving unit configured to receive an operation for selecting any one of the waveform processing results acquired by the waveform processing execution unit; and
a waveform processing result storage unit configured to store the waveform processing result selected by the waveform processing result selection receiving unit.

(Sixth Aspect) The chromatogram data processing apparatus according to any one of the first to fourth aspects, further comprising:
a waveform processing result selection receiving unit configured to receive an operation for selecting any one of the waveform processing results acquired by the waveform processing execution unit; and
a waveform processing parameter storage unit configured to store, as the value of the waveform processing parameter to be applied to waveform processing for a subsequently acquired chromatogram, the value among the plurality of values of the predetermined waveform processing parameter that was applied in the waveform processing from which the waveform processing result selected by the waveform processing result selection receiving unit was obtained.

### DESCRIPTION OF REFERENCE NUMERALS

10 . . . Chromatograph unit
11 . . . Liquid feed pump
12 . . . Sample introduction unit
13 . . . Column
14 . . . Detector
20 . . . Data processing apparatus
21 . . . Chromatogram generation unit
22 . . . Parameter designation receiving unit
23 . . . Parameter value combination generation unit
24 . . . Waveform processing unit
25 . . . Display control unit
26 . . . Chromatogram storage unit
27 . . . Parameter value combination storage unit
28 . . . Final result storage unit
29 . . . Parameter storage unit
31 . . . Input unit
32 . . . Display unit

1. A chromatogram data processing apparatus, comprising:
a chromatogram acquisition unit configured to acquire a chromatogram;
a parameter designation receiving unit configured to receive an operation for designating a plurality of values for a predetermined waveform processing parameter;
a waveform processing execution unit configured to execute waveform processing on said chromatogram by applying each of the plurality of values of said predetermined waveform processing parameter received by said parameter designation receiving unit; and
a display control unit configured to cause a display device to display a first waveform processing result acquired by waveform processing to which one of the plurality of values of said predetermined waveform processing parameter is applied, and a second waveform processing result acquired by waveform processing to which another one of said plurality of values is applied.

2. The chromatogram data processing apparatus according to claim 1, wherein
said display control unit causes said display device to transition from a first state, which is a state displaying said first waveform processing result, to a second state, which is a state displaying said second waveform processing result,
the apparatus further comprising:
a transition stop operation receiving unit configured to receive an operation for stopping the transition of said display device from said first state to said second state, provided in said display control unit.

3. The chromatogram data processing apparatus according to claim 1, wherein
said parameter designation receiving unit is configured to receive designation of an upper limit value, a lower limit value, and a data point setting value representing the number of data points to be set for said predetermined waveform processing parameter.

4. The chromatogram data processing apparatus according to claim 1, wherein
said parameter designation receiving unit is configured to receive designation of an upper limit value, a lower limit value, and a step value representing an interval of change for said waveform processing parameter for said predetermined waveform processing parameter.

5. The chromatogram data processing apparatus according to claim 1, further comprising:
a waveform processing result selection receiving unit configured to receive an operation for selecting any one of the waveform processing results acquired by said waveform processing execution unit; and
a waveform processing result storage unit configured to store the waveform processing result selected by said waveform processing result selection receiving unit.

6. The chromatogram data processing apparatus according to claim 1, further comprising:
a waveform processing result selection receiving unit configured to receive an operation for selecting any one of the waveform processing results acquired by said waveform processing execution unit; and
a waveform processing parameter storage unit configured to store, as the value of said waveform processing parameter to be applied to waveform processing for a subsequently acquired chromatogram, the value among said plurality of values of the predetermined waveform processing parameter that was applied in the waveform processing from which the waveform processing result selected by said waveform processing result selection receiving unit was obtained.
